(19) United States
(12) Patent Application Publication
(10) Pub. No.: US 2018/0182505 A1
(43) Pub. Date: Jun. 28, 2018

(54) WASTE REPOSITORY FOR THE STORAGE OF RADIOACTIVE MATERIAL AND METHOD FOR ITS CONSTRUCTION

(71) Applicant: Reiner Diefenbach, Amöneburg (DE)

(72) Inventor: Reiner Diefenbach, Amöneburg (DE)

(21) Appl. No.: 15/805,307

(22) Filed: Nov. 7, 2017

Related U.S. Application Data
(63) Continuation of application No. PCT/EP2016/060170, filed on May 6, 2016.

(30) Foreign Application Priority Data
May 7, 2015 (DE) 10 2015 208 492.2

(51) Int. Cl. G21F 9/24; G21F 9/36

(52) U.S. Cl. CPC G21F 9/24; E21D 13/00; G21F 9/36

(57) ABSTRACT

The invention relates to a repository (1) for storing radioactive material in a rock formation, wherein there are at least two cavity systems (4, 6) which are spaced apart from each other, and wherein a first cavity system (4) forms a repository chamber (10) for the radioactive material in containers (20) and the second cavity system (6) forms an access system (12), wherein the rock formation is a mountain mass (2), in which the first and second cavity systems (4, 6) are connected to each other via connecting passages (14) at a plurality of transition points, wherein the first cavity system (4) forms a repository chamber (10) in which the containers (20) are free-standing and are accessible and removable, even when the repository chamber (10) is completely full, and the second cavity system (6) forms an access system (12) enabling permanent access and being at a distance from the repository chamber (10) such that the access system (12) forms a radiation-free region for access to the repository chamber (10) at different locations of the first cavity system (4).

This application is a continuation of International Patent Application No. PCT/EP2016/060170 filed May 6, 2016, which claims priority to German Patent Application No. 10 2015 208 492.2 filed May 7, 2015, which are hereby incorporated herein by reference.

The invention relates to a waste repository for the storage of radioactive and heat-producing material in dry rock, comprising at least one cavity, which is surrounded by dry rock material and forms the repository space for radioactive material, a method for producing a waste repository for the storage of radioactive material, and the utilization of a mountainous mass as a waste repository.

Because of their initially still very high activity, the spent fuel rods are to be cooled in a cooling pool and then, before being conveyed to a final waste repository site, they must be kept over several decades for intermediate storage in containers appropriate for the storage and transportation of radioactive material. Central intermediate repositories are located in Ahaus and Gorleben. Each location has a capacity for 420 bulk containers.

In Germany, for example, the intermediate storage containers are permitted to remain in an intermediate repository for a maximum of 40 years. By this time, at the latest, they should be transported to a final waste repository.

In the case of the fuel rods being reprocessed in a reprocessing plant, highly radioactive fission products are generated in the process that will be vitrified in glass. The specially designed vitrified waste block containers are made of 50 cm thick stainless steel walls and must also be kept in intermediate storage to decay for several decades until the temperature has sunk to the point that allows the containers to be brought to a final repository.

Every year, 12,000 tonnes of highly radioactive waste is produced in 440 nuclear power plants in 30 countries. The end of 2012 saw the total worldwide accumulation of HLW (high level waste) at 320,000 tonnes.

The common opinion of experts is that the final disposal of HLW should be provided in deep geological formations. The permanent protection against radiation is to be ensured by the presence of several barriers. The first barrier is of a technical nature and consists, for example, of the enclosure of the HLW in vitrified waste block containers and/or the packing of the HLW into radiation-protected containers made of iron, stainless steel or copper. These containers are so well insulated against nuclear radiation that a person can stand nearby without risk or damage. After prolonged storage, the geological barriers should come into effect because, according to experts, with the currently known concepts, the technical barriers will after a certain period of time be no longer effective as a result of corrosion. If the geological barriers are to be effective, an absolute precondition—according to all currently known concepts—is that no water will seep into the final repository. The presence of water would result in a radioactive contamination of the repository's natural surroundings.

It is not to be excluded that the radiation emitted by the HLW will be accompanied by gas formation. The long-term effect that this gas formation has on the disposed waste material in the air-tight containers is so far not fully understood.

A narrow selection of five materials world-wide, namely granite, clay, salt (salt stalks), Opalinuston and tuff, are the only ones considered world-wide as suitable surrounding materials for the disposal of nuclear waste. Only in Germany, e.g. in Gorleben, there exist salt stalks still regarded as useful material. Since salt is water-soluble and since the seepage of water into a subterranean salt stalk sometime over a period of 1,000,000 years cannot be ruled out, an adequate barrier function of salt stalks for the final disposal of nuclear waste cannot be reliably expected. The static properties required for a final repository for nuclear waste cannot in the case of salt stalks be guaranteed for extended periods.

Clay is a malleable material and demonstrates a far too little static stability. It is not possible to make any firm predictions in respect of the spatial changes in clay formations that can occur over a time-period of 1,000,000 years. A later recovery of the disposed barrels of nuclear waste is practically impossible. The warming of the clay through highly radioactive and heat-producing nuclear waste as a result of desiccation and cracking would severely reduce its static properties and its ability to insulate against nuclear radiation. Clay formations can therefore not be used for the final disposal of highly radioactive and heat-producing nuclear waste.

As known from the publication “Departementsserie 2008:73” (ISBN 978-91-38-23062-6), granite rock is used as a repository in Sweden and Finland for the subterranean storage of low and medium radiation level nuclear waste. The repositories are situated at a maximum of 100 m below the earth's surface.

In Sweden and Finland, final repositories at depths of between 400-700 m for highly radioactive and long-term radiating nuclear waste are planned. They are not adequately protected against water-seepage.

In Switzerland, Opalinston is favoured for the deep disposal of highly radioactive nuclear waste despite its water content of 6.6% and a porosity level of 18.3 Vol %.

Tuff is regarded in the USA as usable for the final disposal of highly radioactive nuclear waste. Compared to granite, tuff is relatively light, soft and porous.

There are three damage categories that are relevant for an end-repository: the static safety, water seepage and damaged containers.

All the repositories for highly radioactive nuclear waste planned around the world are situated under the earth's surface and under the groundwater and sea level. Access to them is via one or two downward sloping access routes (ducts or chutes). It is generally not intended to enable a retrieval of the highly radioactive nuclear waste once it has been disposed of and this would be only possible—if at all—under difficult technical circumstances and would involve considerable costs.

The disposal at a depth of 3,000 m would offer better isolation from the biosphere, but would make long-term surveillance and retrievability virtually impossible.

Around the world there are currently no end-repositories for highly radioactive and heat-producing nuclear waste in operation.

Thus, it is an object of the invention to provide a safe and long-term viable end-repository for highly radioactive and heat-producing nuclear waste ensuring that the radioactive waste can be at all times supervised and retrieved, and to provide a method for the construction of the end-repository.

The above object is achieved be the features defined in claims 1, 13 and 18.

The invention advantageously provides that the rock formation be a mountainous mass, in which the first and second cavity systems are connected to each other via connecting passages at various transition points, wherein the first cavity system forms a repository chamber in which the containers are free-standing and are accessible and removable, even when the repository chamber is completely full, and the second cavity system forms an access system enabling permanent access and being situated at such a distance from the repository chamber that the access system forms a radiation-free region for access to the repository chamber at different locations of the first cavity system.

As a cavity, there are provided at least two technically and functionally independent cavity systems in the mountainous mass that are spatially connected to each other via connecting passages at various transition points, wherein the first cavity system forms the end-repository and the second cavity system forms an access system that is situated at such a distance from the end-repository that the access system forms a radiation-fee area for the access to the end-repository which is independent of the first cavity system at different locations in the first cavity system.

It is understood that the mountainous mass be preferably a natural mountainous mass. It is, however, in the spirit of the proposed invention also conceivable that the mountainous mass be of an artificial construction, e.g. made of granite blocks or of a mixture of granite blocks or stones and durable concrete. A construction of this kind could be necessary where no suitable rock formations exist.

Further, it is a matter of course that, although the invention relates to a final repository that is suitable for self-contained storage of radioactive material for unlimited durations, it is all the more suitable as an intermediate storage facility and is suitable for low-radioactive material.

The proposed solution has the following advantages for the terminal storage of highly radioactive and heat-producing nuclear waste:
protection against radioactive radiation for unlimited time periods
enduring preservation of the HLW containers (as a first technical protection against radioactive radiation) and thus temporally unlimited protection against radiation
retrievability at any time in the future, e.g. in less than 24 hours, of any individual container of HWL assigned to terminal storage
possibility to reprocess the HLW at any time in the future, e.g. by transmutation
open storage of the containers of HLW and the resultant possibility to keep each individual terminally stored container under surveillance for an unlimited time period with respect to integrity, radioactivity, temperature and humidity
guaranteed static safety of all spatial structures for an unlimited time period
safety from earthquakes by the monolithic granite surrounding the repository, wherein, due to the physical properties of the granite, a collapsing of the cavity systems is excluded
physical prevention of a possibility of flooding of the final repository with water, particularly with ground water, sea water, water from inland lakes, water from flooding rivers or tsunamis, achieved by the elevated position of the repository above all possible water levels
storage of the containers in the final repository at a distance above the water table and the sea level and above the maximum flood gauge of surrounding rivers
temporally unlimited possibility to spatially expand the final repository for HLW
safe access to, and exit from, the final repository for HLW for unlimited time periods
safe access to the inner space of the final repository via a safe and technically and functionally independent access system at any time
permanent, i.e. temporally unlimited passive function of the final repository after is has been entirely filled, without the need for technical aid and/or human or electronic control or surveillance activities.

Preferably, it is provided that that both cavity systems are installed in the rock-formation while extending substantially parallel to each other and with a generally upward gradient.

The parallel arrangement ensures that any location within the repository can be accessed at any time. The upward gradient of the cavity systems reliably prevents the gathering of water and moreover enables a passive, but inevitable, ventilation inflow and ventilation outflow. As a result of an upward gradient of the ground surface of the repository chamber of e.g. about 5%, there is effected, under the influence of gravity, an automatic discharge of rain water or other intruding water. Further, by means of the generally ascending orientation of the tunnels of the cavity systems, a respective passive ventilation inflow and ventilation outflow system is created for the repository chamber and/or the access system. The passive ventilation inflow and ventilation outflow is achieved by the permanent passive heat dissipation of the HLW in the repository chamber by an airflow in upward direction in combination with a passive supply of fresh air through the lower entrance and exit opening. The passive ventilation inflow and ventilation outflow in the first and/or second cavity system can further by effected by the pressure difference and respectively the chimney effect between a lower entrance and exit opening and an upper exit opening. All in all, the filled repository is, without human or mechanical assistance, fully functional. Particularly, it is not required to keep machines or electronic control systems ready for operation.

The first and/or second cavity system can each comprise a lower entrance and exit opening. The first and/or second cavity system is respectively designed as throughgoing channel or tunnel.

The entrance and exit opening can be used for entering and leaving the first and respectively second cavity system. Further, the entrance and exit opening can serve for discharge of water intruding within the first or second cavity system, with simultaneous supply of air from the ambience into the first or second cavity system. The entrance and exit opening can be barred by a lattice, for instance, wherein the passage openings of the lattice structure can be variable, thus allowing for control of the passing airflow.

According to a preferred embodiment, the first and second cavity systems each comprise a separate exit opening at the upper end, leading into the ambience.

Via the separate exit opening, the exhaust air can be discharged from the first and/or second cavity system respectively into the ambience. The exit opening can comprise a lattice with adjustable passage cross section for air so that the exhaust air flow from the first and/or second cavity system can be controlled by changing the passage cross section.

The connecting shafts do not run in a straight line and are substantially horizontal or oriented with a downward slope to the first cavity system. Preferably, the connecting shafts are curved. This shape of the connecting shaft would prevent radioactive contamination of the second cavity system in the event of a container developing leaks. Preferably, in the connecting passages, closure means can be provided such as e.g. doors or sluices can be provided which will prevent an exchange of fluid between the first and second cavity systems in the closed state and will allow for such exchange in the open state.

The rock formation is preferably a crystalline rock, e.g. monolithic granite-rock.

Compared to all other natural materials, granite is, because of its homogenous monolithic structure, its high mass, its great hardness and its bending tensile strength, particularly suitable for requirements on a repository for HLW. Granite can withstand temperatures of up to 800° C., is water-insoluble, salt-resistant, highly abrasion-resistant, and many granite formations are permanently weather-resistant.

At least the first cavity system, serving as a repository space, comprises a passive ventilation system that ensures a dissipation of excess heat. Preferably, both cavity systems for the final repository and for the secure access comprise the passive ventilation inflow and ventilation outflow system which will ensure heat dissipation and continual supply of fresh air without the help of active ventilation systems.

The second cavity system is situated at a distance of at least 10 meters, preferably 12 meters, from the first cavity system. With such a minimum distance, the protection against radiation can be guaranteed in the second cavity system.

The second cavity system can extend parallel, or parallel with vertical displacement, to the first cavity system. The second cavity system should run preferably parallel to the first cavity system and, from a vertical perspective, with its base at the same height or vertically positioned above the first cavity system.

According to a preferred embodiment, both cavity systems can comprise, at predetermined intervals, ventilation outflow channels preferably extending with a curved trajectory through the rock formation and with a downward slope to the outside. These ventilation channels inevitably take on the function of a passive ventilation system in the repository. As a result of the specially designed downward slope and curvature of the ventilation channel, no water can seep in and no radiation can escape to the outside.

According to a particularly preferred embodiment, the cavity systems are provided as a spiral-formed tunnel system, preferably arranged like a double or multiple helix. It is further understood that tunnel systems can generally have a varying cross-section and can run polygon-shaped in the spiral. It is further understood that especially the first cavity system can comprise a plurality of tunnel systems extending parallel to each other that are accessible via the second cavity system, but preferably from a single tunnel system.

The second cavity system can be arranged as an access system in a space-saving manner, preferably forming the inner part.

At least the first cavity system and, if necessary, also the connecting passages should have such a width that containers with radioactive contents, in particular nuclear waste containers, can be transported to any part of the cavity system and in the event of a filled repository can be accessed there and also at a later date be removed from there.

The containers containing the radioactive material are designed to be stored in the first cavity system at a distance from the floor area. This ensures that the containers do not come into contact with water.

The first cavity system can also have branch tunnels in order to enlarge the repository space, as long as the basic preconditions that guarantee the accessibility, the water drainage, the ventilation inflow and outflow and the retrievability of the containers are maintained.

At least the first cavity system can have control systems for temperature, radiation and visual surveillance.

The first cavity system can be equipped with an unmanned transportation system.

The flow cross-section of the ventilation channels can be adjustable so that the ventilation volume can be controlled or regulated.

According to the method of the invention, a mountainous mass will be used as the rock formation, wherein a first and a second cavity system are constructed in the form of tunnels in the rock formation of the mountainous mass and are connected to each other via connecting passages at a plurality of transition points. The first cavity system is used as an end-repository for free-standing containers which are accessible and removable also when the end-repository chamber is entirely filled. The second cavity system is constructed at such a distance from the first cavity system that the second cavity system forms a permanent radiation-free space for access to different sites of the at least one first cavity system.

The cavity is constructed in the form of a cavity complex, wherein at least two technically and functionally independent cavity systems, spatially connected to each other, are constructed using tunneling machines. A first cavity system will be used as an final repository and a second cavity system will serve as an access system for access to different points of the first cavity system, the access being independent of the first cavity system, wherein the second cavity system will be constructed with a distance from the first cavity system that the second cavity system will form a permanently radiation-free zone.

Preferably, these cavities can be constructed using tunneling machines, wherein the cavity system is not bound to a specific tunnel cross section and can also contain larger chambers or branch-tunnels and bypasses in relation to the tunnel cross section.

Both cavity systems will be cut into the mountainous mass generally parallel to each other and basically at an upward gradient.

The connecting shafts are to be constructed not in a straight line and generally horizontal or at a gradient to the first cavity system.

Due to the heat release by the free-standing containers and supply of fresh air, the first cavity system can permanently dissipate heat by convection.

The second cavity system, as a result of the pressure difference between a lower entrance and exit opening and an upper exit opening, can be subjected to permanent air flow.

The connecting passages are constructed not in a rectilinear orientation and extend substantially horizontally or with a gradient to the first cavity system.

Preferably for the first cavity system, curved ventilation channels will be constructed in predetermined intervals, e.g. on each floor or every 360°, sloping down to the outside.

In accordance with the preferred embodiment of the invention, the cavity systems are to be constructed spiral-shaped and preferably in the form of a double-helix.

The cavity system as final repository should be understood as a continuous sequence of cavities suitable for the terminal storage of HLW. The dimensions of these cavities are such that transport vehicles would still be able to maneuver even when full container capacity has been reached and every container, including those put in storage, would remain accessible at any point of time and for unlimited periods of time.

The combination of using a mountainous mass as a final repository for HLW with the elevated position of the final repository in a mountainous mass, the gen ometric shape of the repository, e.g. in the shape of a double helix, with a technically and functionally independent secured access system and the resultant escape route, and the use of a spiral-shaped definitive final repository with free-standing HLW-containers that can be permanently monitored and thus can be kept secure, offers particular advantages, namely passive ventilation inflow and outflow, water-drainage and the physical retrievability of the containers for unlimited periods of time.

The ventilation of the cavity systems can be regulated by the reduction of the cross-sections of the ventilation channels.

Hereunder, an exemplary embodiment of the invention will be explained in greater detail:

The Figures show:

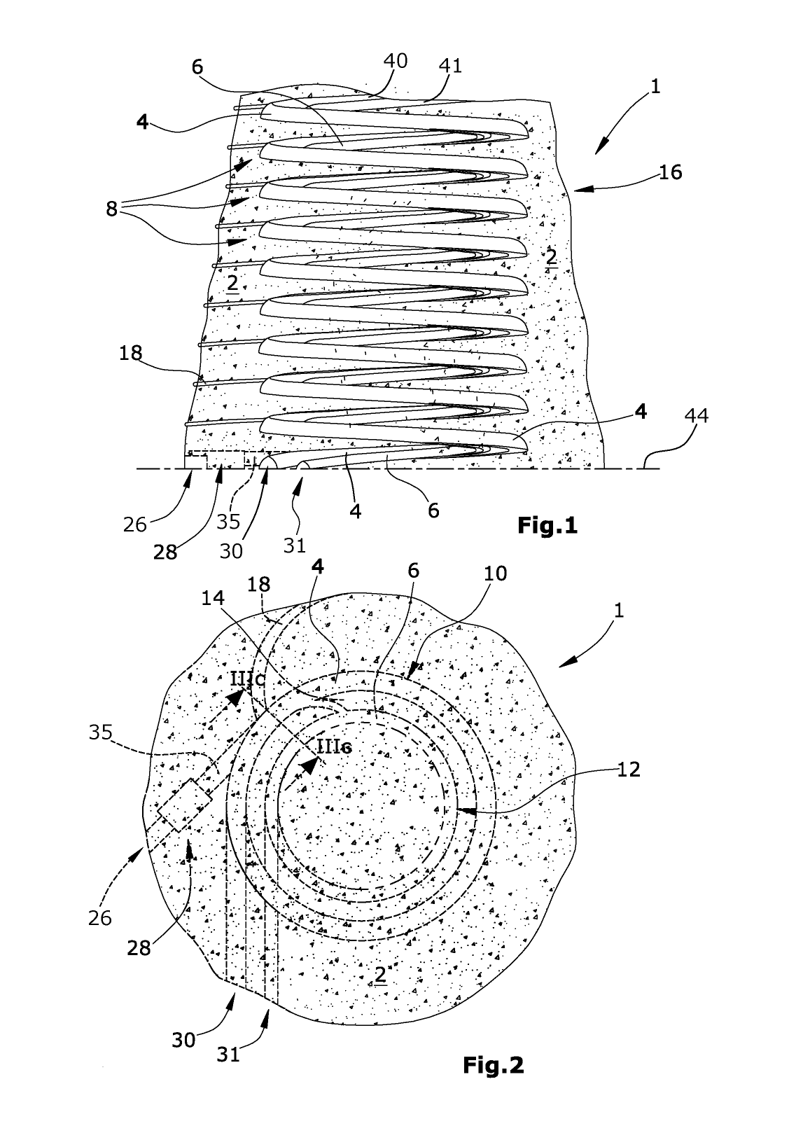

FIG. 1 a schematic lateral view of a first exemplary embodiment of the final repository in the mountainous mass,

FIG. 2 a cross-sectional view of the first exemplary embodiment of the final repository,

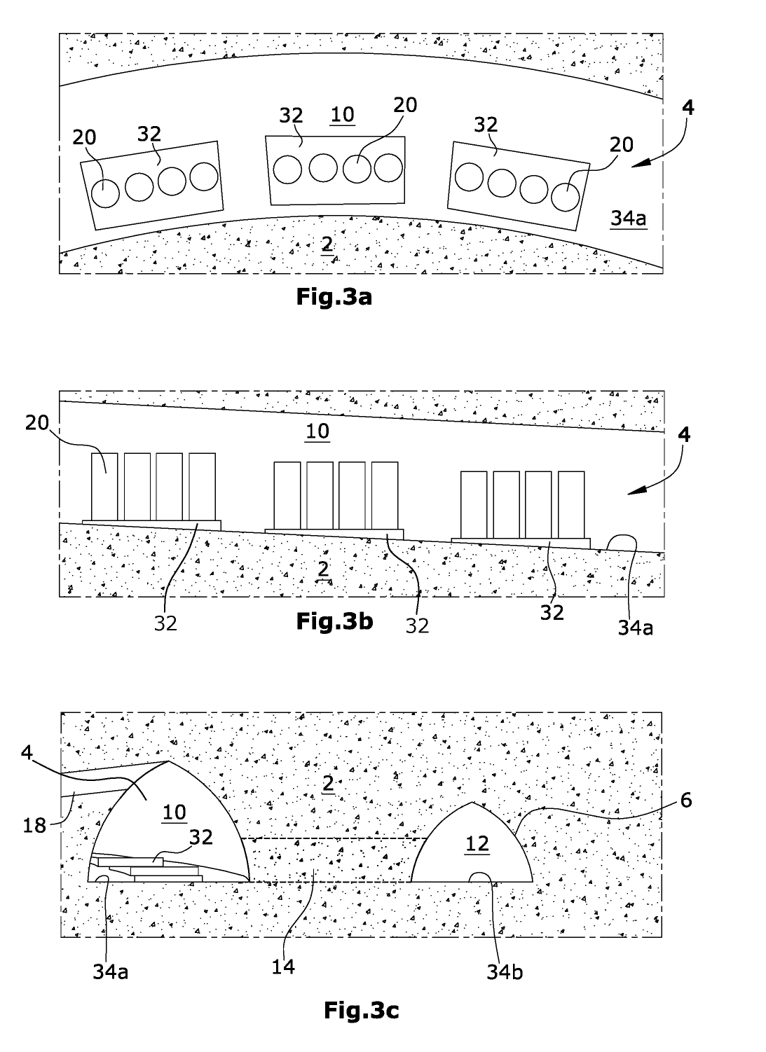

FIGS. 3a, 3b, 3c cross-sectional views of the cavity systems of the first exemplary embodiment,

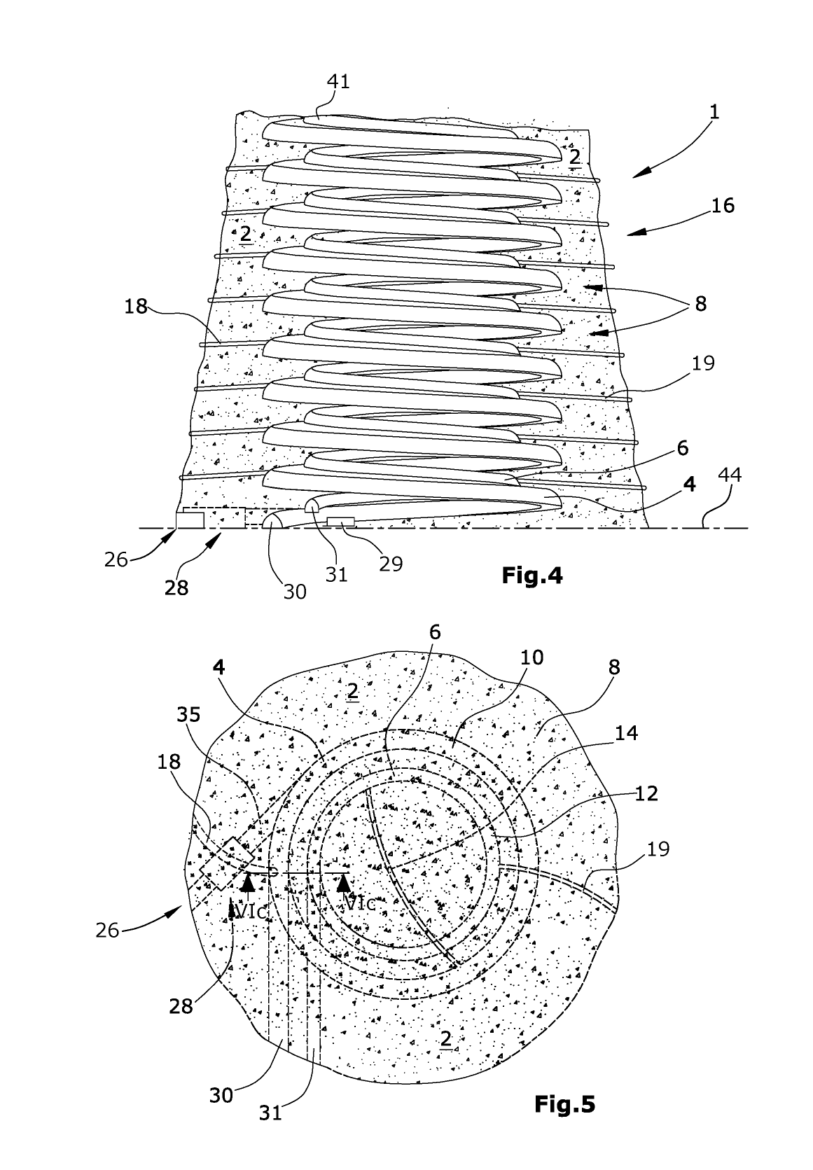

FIG. 4 a schematic lateral view through the second exemplary embodiment of a final repository,

FIG. 5 a cross-sectional view of the cavity systems of the second exemplary embodiment,

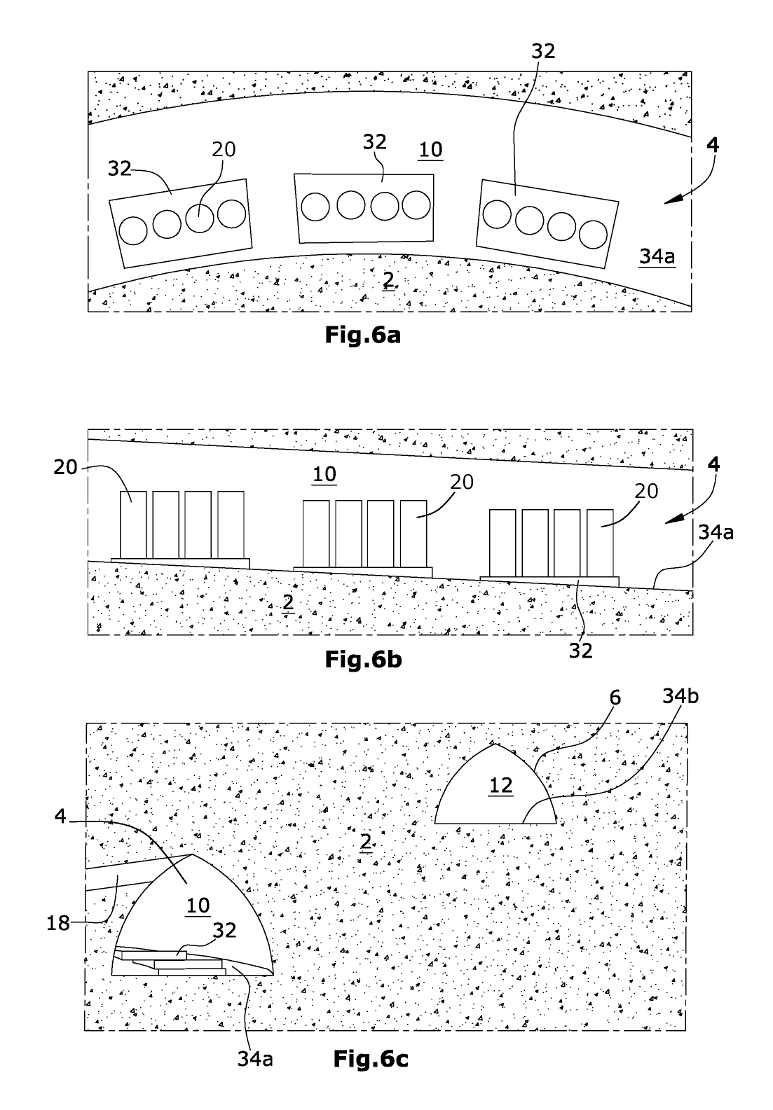

FIGS. 6a, 6b, 6c cross-sectional views of the cavity systems of the second exemplary embodiment,

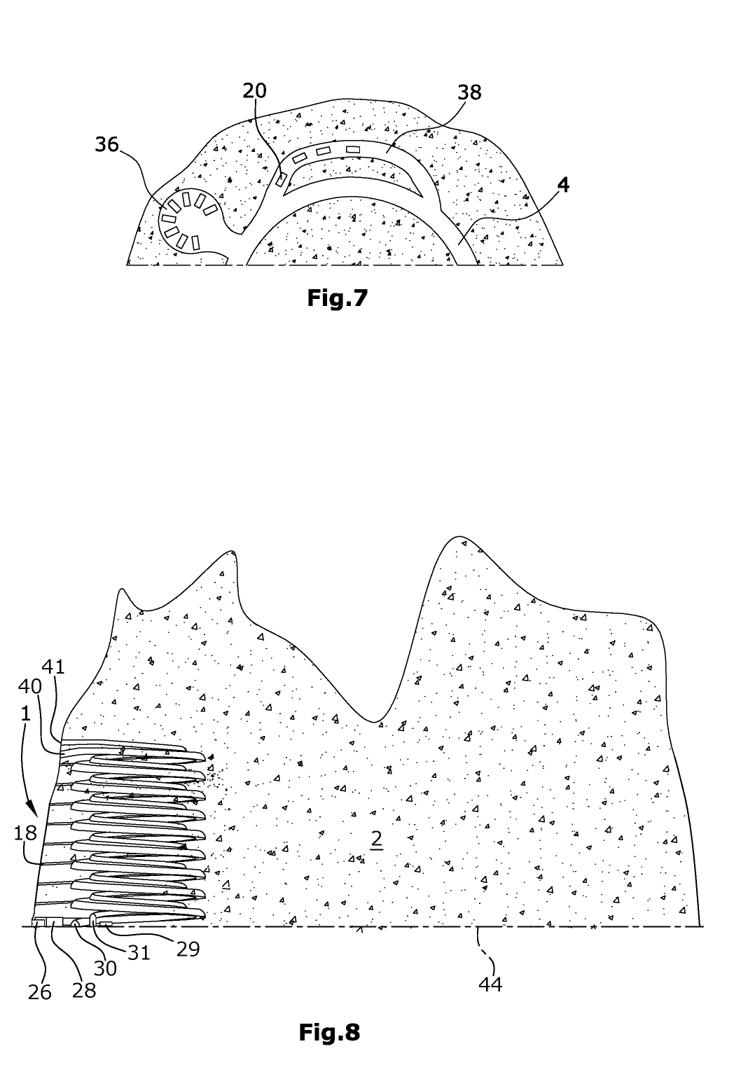

FIG. 7 alternative exemplary embodiments of the first cavity system, and

FIG. 8 the structural arrangement of the repository in a mountainous mass.

The highly radioactive and heat-producing nuclear waste-material will be terminally stored in a repository 1 in a mountainous mass 2, e.g. monolithic granite which at one point protrudes above the surrounding earth's surface. This structural arrangement in a mountainous mass 2 offers considerable advantages for the terminal deposition of highly radioactive nuclear waste compared with other known places for terminal deposition, as described hereunder:

According to a preferred exemplary embodiment shown in FIG. 1, the repository 1 in the form of two cavity systems 4, 6 resembles a double-helix 16 with two parallel and preferably continually upward-sloping tunnel shafts that are driven up into the mountainous mass 2. The two initially spatially separate spirals will be spatially connected with each other preferably at each level 8 by means of a horizontal and curved connection shaft 14. The first cavity system 4 forms the definitive final repository 10 for the free-standing containers 20 with highly radioactive and heat-producing nuclear waste (HLW). The space inside the first cavity system 4 of an e.g. parabolic cross section has a cross-sectional width at the base of e.g. 12 m and, in the middle, a height of e.g. 9 m, and the gradient of the floor area 34a is approximately 5%. Because of the gradient, every level 8 is at a safe distance—structurally and in terms of protection from radiation—from the adjacent level 8. The cross-section of the wall and ceiling areas will be for structural reasons preferably constructed arch-shaped, e.g. parabolic. The circle that forms the inner limit of the first cavity system 4 in the horizontal section has for example a diameter of about 150 m. The circle that forms the outer limit of the first cavity system 4 has a diameter of e.g. 174 m. This will result in a tunnel width of the first cavity system 4 of e.g. 12 m. Beside the lower entrance and exit opening 30 to the first cavity system 4 there is arranged a separate entrance and exit opening 26 to a temporary storage chamber 28 inside the mountainous mass 2 for new container arrivals 20, so that these containers can be individually transported via a connecting passage 35 to the first cavity system, from where the containers 20 can be transported to a specified storage place e.g. via an automatic transport system (not illustrated). The lower entrance and exit openings 30, 31 of the first and second cavity systems 4, 6 and the entrance and exit opening 26 of the temporary storage chamber 28 are substantially arranged on a common access level 44 via which the nuclear final repository 1 can be reached at the lower end. Other separate chambers 29 can be constructed within the mountainous mass 2 for the purpose of technical work, e.g. for the repackaging of radioactive waste, or for the installation of a command and control center, offices and break rooms for the staff.

The second, preferably inner cavity system 6, having an e.g. parabolic cross section, serves as an access system 12 and as an escape route. This area is a radiation-free area and ensures secure access to any sites in the final repository and a permanently available exit route for the entire life of the nuclear final repository 1. The second cavity system 6 is situated at an unobstructed distance of at least 6 m, e.g. about 12 m, preferably inside the first cavity system 4. This second cavity system 6 should essentially run parallel to the first cavity system 4. The second cavity system 6 can for example have a cross-sectional tunnel width at the base of about 9 m and in the middle a height of about 6 m. The second cavity system 6 can also run vertically displaced above the first cavity system 4, as shown in FIG. 4. The base of the second cavity system 6 could, for example, run about 11 m above the base of the first cavity system 4. Ventilation channels 18 run outwards from the first cavity system 4 on each level 8 (each time after reaching 360°), e.g. with a gradient of at least 1.5%, preferably with a slight curve.

According to a modified embodiment, provided that the second cavity system 6 can be directly constructed in its final configuration, it is possible to construct only one ventilation channel, provided with an exit opening 41, at the upper end of the second cavity system 6. In this case, the second cavity system 6 will terminate at the upper end in a ventilation opening 41 that leads into the open atmosphere. The advantage of this is that the base of the second cavity system 6, as shown in FIG. 1, will run at the same height as the base of the first cavity system 4. The connecting shafts 14 at each level 8 between the first cavity system 4 and the second cavity system 6 will be respectively about 12 m long, for instance.

The final repository 1 is situated at a height that would be in any case well above sea level and e.g. at least 50 m above an altitude that ground water or flooding rivers could maximally reach in the surroundings of the final repository 1.

The nuclear final repository 1 for highly radioactive and heat-producing nuclear waste is set in a mountainous mass 2 of monolithic granite. The minimum wall thickness of the first cavity system 4, e.g. a tunnel system that will form the definitive final repository chamber 10, should be at least about 6 m. In principle, the minimum wall thickness in this geometric formation can be freely determined and can also have larger dimensions. Unlike all other concepts so far known, when HLW has been terminally stored in the final repository 1, the primary radiation shield will be permanently maintained by the containers 20. This first technical shield is made of preferably corrosion-resistant metal and ensures adequate and permanent protection against radiation for humans in close proximity. Since the first technical radiation shield in the described final repository 1 can be maintained permanently, the radiation shield effect of the rock formation is functional as an additional, second radiation shield. What is important is that the spatial structure of the final repository 1 is permanently maintained. In the case of granite, this is guaranteed for extremely long periods of time.

The nuclear final repository 1 for highly radioactive and heat-producing nuclear waste will be set in a mountainous mass 2 preferably of monolithic granite having a great mass, a high degree of hardness and flexural rigidity. The spatial structure of the final repository 1 cannot therefore be compromised by an earthquake. Since the lower entrance and exit openings 30, 31 and thus also the access level 44 of the final repository 1 are situated above sea level at a height of at least 50 m above the height that ground water or flooding rivers in the surroundings of the final repository could reach, water penetration as a result of an earthquake is excluded.

The monolithic granite which has a wall thickness of at least 6 m will provide, by virtue of its great homogenous mass and high degree of hardness, permanent protection against possible airplane crashes. As a result of its high and homogenous mass with its high degree of hardness and flexural rigidity monolithic granite provides the highest structural safety imaginable. A collapse of its spatial structure is to all intents and purposes impossible.

The capacity of the final repository 1 will be dimensioned in accordance with the amount of highly radioactive and heat-producing nuclear waste that is planned to be terminally stored there. In Germany, until the end of nuclear electricity generation, this will amount to about 10,000 tons of nuclear waste. That corresponds to about 3,000 of today's model of containers.

The capacity of the final repository 1 can, if required, be expanded, because mining machines, e.g. tunneling machines can remain fully operational in the final repository 1 at the upper end of the tunnel.

The second cavity system 6 and the connecting shafts 14 will be designed dimensionally in such a way that a permanent supply of mining machines and of all necessary spare parts can at all times be ensured. The mining work in the first cavity system 4 should preferably be one level (360°) ahead of the terminally stored containers 20 with nuclear waste. A temporary walling-off of the terminally stored containers 20 from the extension area in the first cavity system 4 can be provided as a supplemental safety measure.

The highly radioactive nuclear waste contained in the containers 20 and barrels to be terminally stored produces a high amount of heat as a result of the continual disintegration processes, said heat being dissipated through the surfaces of the containers 20 to the air in the first cavity system 4. This permanently generated heat is the motor for the airflow that continually transfers the heat outside by convection. Independent of this, however, a continual airflow will develop as a result of the existing difference in pressure between in the area of the lower entrance and exit openings 30, 31 of the final repository 1 and the higher-situated ventilation outflow ducts 18, 19 and the outlet openings 40, 41 of the final repository 1 which, because of the difference in height, are situated in an area of lower air pressure (chimney effect). The ventilation outflow ducts 18, 19 are preferably situated at every level of at least the first and optionally also of the second cavity system 4, 6 preferably in the respective thinnest area of the rock—beginning under the highest extreme point of the respective cavity systems 4,6—and lead with a slight gradient in a curved passage outwards. The gradient outwards ensures that no water from the outside can intrude into the cavity systems 4, 6. The curved passage of the ventilation outflow ducts 18 is designed in such a way that no direct radiation from the first cavity system 4 can penetrate outwards. The diameter and respectively the height of the ventilation outflow ducts 18, 19 and of the upper outlet openings 40, 41 should be for example 2.20 m so that they can also be used as emergency exits. The ventilation outflow ducts 19 and the upper exist opening 41 of the second cavity system 6 can be constructed in the same way. Every ventilation outflow duct 18, 19 and the upper outlet openings 40, 41 can be equipped, in their outer area, with a controllable or adjustable lamellar curtain made of very stable material, like e.g. carbon fiber compounds, so that heat transfer and supply of fresh air can be regulated in each area of the final repository. The dimensions of the ventilation outflow ducts 18 and 19 and of the upper outlet openings 40, 41 and of the lower entrance and exit openings 30, 31 will be selected to ensure the passive circulation and respectively discharge of the air (without ventilator fans).

The constant supply of fresh air via the lower entrance and exit openings 30, 31 is a direct result of the permanent heat transfer and the chimney effect. To the same extent that air is passively transferred outwards via the ventilation outflow ducts 18, 19 and the upper outlet openings 40, 41, fresh air will flow into the first and second cavity systems 4, 6 in the area of the lower entrance and exit openings 30, 31 at the base of the cavity systems 4, 6 of the final repository 1. The entrance and exit openings 30, 31 are preferably barred by a lattice with adjustable cross section wherein the air flow entering the cavity systems 4, 6 can be adjusted by adjustment of the passage cross section.

The height position of the final repository 1 in a mountainous mass 2 reliably prevents flooding by ground water, a rising sea level, temporary river floods or a tsunami. Rain water which could seep into the first or second cavity system 4, 6 through cracks will be transferred outwards because of the continual downward gradient to the entrance and exit openings 30, 31 directly at the base on the access level 44 or via the ventilation outflow ducts 18, 19 (passively operating system without any additional provisions, like e.g. the installation of pumps). As a result of the permanent protective effect of the containers 20, any water that may escape will not come into contact with the stored nuclear waste and will therefore not be contaminated. If required, it can be analyzed.

The protection against corrosion for the containers 20 made of iron, copper or stainless steel for the terminal storage of highly radioactive and heat-producing nuclear waste is a condition resulting from the absence of water. Because of the altitude of the final repository 1, flooding is an impossibility. Small quantities of rain water could seep through cracks in the repository's granite structure into the first and second cavity systems 4, 6. Due to the downward gradient of the cavity systems 4, 6, these small quantities of rain water will be transferred downwards into the area of the lower entrance and exit openings 30, 31 on the access level 44 of the cavity systems 4,6 and can be discharged via the lower entrance and exit openings 30, 31. It is, however, more probable that the small quantities of intruding rain water will evaporate as a result of the strong air circulation and the high temperatures and be transported outwards with the extracted air. A contamination of the water is not possible.

As a result of the physical properties of granite, the altitude of the repository 1, the geometric shape of the continuously rising double helix, the passive heat and water discharge and the non-stop supply of fresh air, it is achieved that the access to and exit from the final repository chamber 10 of the final repository 1 is permanently ensured.

Since the containers 20 with highly radioactive nuclear waste scheduled for terminal storage are placed, free standing, on platforms 32 in the middle of the first cavity system 4, a permanent visual surveillance, e.g. by means of cameras, temperature controls with sensors and radiation monitoring, e.g. by means of fixed measuring devices, is possible. In the event of damage, a container 20 can be immediately retrieved and secured. The air quality, its flow speed and the air humidity can also be uninterruptedly measured.

The repository is dimensioned in such a manner that, even after it has been completely filled, its permanent functionality is safeguarded without the use of additional technology such as e.g. pumps, ventilators or human activity.

The containers 20 with HLW waste scheduled for terminal storage are deposited in the first cavity system 4 in the central region of the upward-leading final repository chamber 10, preferably on platforms 32 made from granite blocks, said platforms extending by at least 20 cm above the ground surface 34a of the first cavity system 4. The platforms 32, being preferably fixed to the ground surface 34a, have a size of e.g. 5 m×10 m and allow for horizontal storage of the containers 20 in spite of the slightly ascending ground surface 34a. Special vehicles can be maneuvered around the platforms 32 and, if required, take up and remove each stored container 20. Each individual container 20 can be retrieved within a short time, e.g. in less than 24 hours. The distances between the platforms 32 are e.g. 3.5 m.

In the future, transmutation technology will possibly be useful to reduce the highly active radiation of the nuclear waste in a faster way and permanently. This process is presently still in the stages of development. Thus, there exists a chance to retrieve already deposited nuclear waste at a later time in order to eliminate or reduce the highly active radiation. The described final repository 1 offers a temporally unlimited possibility to retrieve and re-process already deposited highly radioactive nuclear waste.

Newly arriving containers 20 scheduled for terminal storage will first be conveyed, via a separate entrance and exit opening 26, into the special temporary storage chamber 28 which is located next to the lower entrance and exit opening 30 to the cavity system 4. Said temporary storage chamber 28 can serve as a buffer storage site of the final repository chamber 10 for containers 20 with nuclear waste. Via a short connection duct 35, said chamber is connected to the lowermost starting point of the first cavity system 4, the definitive final repository chamber 10. The individual containers 20 or barrels will be loaded, with the aid of a special forklift, onto a special vehicle at the starting point of the first cavity system 4. This vehicle will autonomously transport the container 20 scheduled for terminal storage to the height at which it is to be terminally stored. The steering of the preferably electrically operated vehicle can be performed e.g. by means of a guiding system which is mounted to the outer wall of the first cavity system 4 similar to a stairlift for handicapped persons, and/or be optically controlled and/or be performed by laser guidance.

When the preferably unmanned and electrically driven vehicle with its container 20 has reached the final storage site, the container 20 will there be taken over by a special transport vehicle which is individually movable and preferably electrically driven, and will be positioned at the scheduled final storage site.

The exemplary dimensions mentioned in the description of the cavity systems 4, 6 will necessitate, in case of required storage capacity of 10,000 tons, a total constructional height of about seven levels 8. Of these, five levels 8 will be occupied by the final repository chamber 10, and respectively one level 8 that is kept free of containers 20 will be used, as a termination space, to provide a safety distance in the upper and lower regions.

FIGS. 1 to 3 show a preferred exemplary embodiment wherein the cavity systems 4, 6 extend parallel to each other and are each arranged on the same plane, as best evident from FIGS. 1 and 3c.

FIGS. 4 to 6 show an alternative exemplary embodiment wherein the cavity systems 4, 6 extend parallel to each other but are vertically offset relative to each other so as to extend on different planes. The ground surface 34a, 34b of the cavity systems 4, 6 has a respective—preferably continuous—upward gradient of about 5 percent, as best evident from FIGS. 3b and 6b.

The ventilation outflow ducts 19 of the second cavity system 6 can be omitted if, on the upper end of the access system 12, a ventilation outflow channel—e.g. leading outside—with an upper exit opening 41 is provided or if the access system 12 leads outside into the ambience.

FIGS. 3c and 6c respectively show a vertical sectional view of the cavity systems 4, 6 of the first and second exemplary embodiments while FIGS. 3a, 3b, 6a and 6b show respective sectional views in a horizontal and respectively vertical plane in the longitudinal direction of the first cavity system 4.

FIG. 7 shows variants of the first cavity system 4 wherein, by providing branches 36, 38, e.g. in the manner of a bypass, additional final repository space 10 is created. Of course, also a plurality of cavity systems 4 can be assigned to a sole cavity system 6. For instance, a plurality of mutually parallel or parallel and vertically offset, preferably spiral-shaped final repository chambers 10 can be assigned to a corresponding access system 12.

FIG. 8 shows the arrangement of the repository 1 in the mountain mass.

1. A repository for storing radioactive material in a rock formation, wherein at least two mutually spaced cavity systems are provided, and wherein a first cavity system forms a repository chamber for the radioactive material in containers, and the second cavity system forms an access system,
wherein the rock formation is a mountain mass, in which the first and second cavity systems are connected to each other at a plurality of transition points via connecting passages, wherein the first cavity system forms a repository chamber in which the containers are free-standing and are accessible and removable even when the repository chamber is filled to capacity, and the second cavity system forms an access system enabling permanent access and being arranged at such a distance from the repository chamber that the access system forms a radiation-free region for access to the repository chamber at different locations of the first cavity system.

2. The repository according to claim 1, wherein both cavity systems extend substantially in parallel to each other and are formed in the mountain mass substantially with an upward gradient.

3. The repository according to claim 1, wherein the first and/or the second cavity system each comprise a respective separate lower entrance and exit opening.

4. The repository according to claim 1, wherein the first and/or the second cavity system each comprise, at the upper end, a separate upper outlet opening into the free ambience.

5. The repository according to claim 1, wherein the connecting passages and the cavity systems are at least partially tunnel-shaped and that the connecting passages do not extend in rectilinear orientation and extend substantially horizontally or with a downward slope to the first cavity system.

6. The repository according to claim 1, wherein the cavity systems each comprise at least one passive ventilation system.

7. The repository according to claim 1, wherein the second cavity system extends parallel to the first cavity system at the same height, or is vertically positioned above the first cavity system.

8. The repository according to claim 6, wherein the venting system comprises, at predetermined intervals, ventilation channels preferably extending with a curved trajectory through the rock formation and with a downward slope to the outside.

9. The repository according to claim 1, wherein the cavity systems are arranged in a spiral-shaped con-figuration and preferably in the form of a double-helix or multiple helix.

10. The repository according to claim 1, wherein the second cavity system is arranged at an inner position relative to the first cavity system.

11. The repository according to claim 1, wherein at least the first cavity system has such a width that containers with radioactive contents, in particular nuclear waste containers, can be transported to any part of the first cavity system and, even when the repository chamber is filled to capacity, are accessible there and removable from there.

12. The repository according to claim 1, wherein the first cavity system can comprise branch tunnels.

13. A method for producing a repository for storing radioactive material, contained in containers, in a rock formation, by producing at least two mutually spaced cavity systems surrounded by rock matter, wherein the first cavity system is used as a repository chamber for containers, and the second cavity system is used as an access system,
wherein the first and the second cavity system are constructed in the manner of tunnels in the rock formation of the mountain mass and are connected to each other at a plurality of transition points via connecting passages, wherein the first cavity system is used as a repository chamber for free-standing containers which are accessible and removable even when the repository chamber is filled to capacity, and wherein the second cavity system is constructed at such a distance from the first cavity system that the second cavity system forms a permanently radiation-free region for access to different sites of the at least one first cavity system.

14. The method according to claim 13, wherein both cavity systems extend substantially in parallel to each other and are formed in the mountain mass substantially with an upward gradient.

15. The method according to claim 13, wherein the first cavity system permanently dissipates heat by convection effected by heat release from the free-standing containers and supply of fresh air.

16. The method according to claim 13, wherein the connecting passages between the cavity systems do not extend in rectilinear orientation and extend substantially horizontally or with a downward slope to the first cavity system.

17. The method according to claim 13, wherein the first cavity system is subjected to forced venting at predetermined distances and that the second cavity system, at least at the upper end, enters into a venting channel leading to the outside.

18. Use of a mountainous mass consisting of a rock formation, preferably granite rock, as a repository according to claim 1.
